(19) United States
(12) Patent Application Publication
(10) Pub. No.: US 2026/0279135 A1
(43) Pub. Date: Sep. 17, 2026

(54) SYSTEM AND METHOD FOR PLAYING A GAME OF CHANCE

(71) Applicant: Bluberi Gaming Canada Inc., Drummondville (CA)

(72) Inventor: Carl NADEAU, Drummondville (CA)

(21) Appl. No.: 19/392,321

(22) Filed: Nov. 18, 2025

Related U.S. Application Data
(60) Provisional application No. 63/772,291, filed on Mar. 14, 2025.

(51) Int. Cl. G07F 17/32; G07F 17/34

(52) U.S. Cl. CPC G07F 17/3211; G07F 17/34

(57) ABSTRACT

A method for playing a game of chance includes providing a graphical user interface that has an upper segment and a lower segment. The method also includes displaying one of a plurality of upper reels on the upper segment, or a plurality of lower reels on the lower segment. The method also includes displaying the one of the upper reels or the lower reels spinning in response to activation of an input device, and displaying a first randomized arrangement of indicia on the one of the upper or lower reels. The method also includes identifying a presence of a special indicia among the first randomized arrangement of indicia. The method also includes displaying the other of the upper reels or the lower reels in response to the identification of the special indicia as a mirror image of the other.

### CROSS-REFERENCE TO RELATED APPLICATIONS

The present application claims priority to U.S. Provisional Patent Application Ser. No. 63/722,291, filed Nov. 19, 2024 and entitled “System and Method for Playing a Game of Chance,” the entirety of which is incorporated by reference herein.

### FIELD OF THE DISCLOSURE

The present disclosure relates generally to games of chance, such as those found at casinos.

### BACKGROUND

Games of chance, like slot machines, have been a fixture of gaming establishments like casinos for decades. Slot machines operate on the principle of randomness, providing players with an opportunity to win monetary rewards based on chance. Slot machines typically include a series of rotatable reels which each present a number of indicia/symbols. Players place a wager and are paid based on the presence of predetermined combinations of aligned indicia on the reels.

There is a continued demand for improvements to games of chance, like slot machines, to enhance the gaming experience.

### SUMMARY OF THE DISCLOSURE

This section provides a general summary of the present disclosure and is not a comprehensive disclosure of its full scope or all of its features, aspects, and objectives.

According to an aspect of the disclosure, a method for playing a game of chance includes providing a graphical user interface that has an upper segment and a lower segment, with the upper segment positioned above the lower segment. The method also includes displaying one of a plurality of upper reels on the upper segment, or a plurality of lower reels on the lower segment. The method also includes displaying the one of the upper reels or the lower reels spinning in response to activation of an input device by a user, and displaying a first randomized arrangement of indicia on the one of the upper or lower reels. The method also includes identifying a presence of a special indicia among the first randomized arrangement of indicia. The method also includes displaying the other of the upper reels on the upper segment or the lower reels on the lower segment in response to the identification of the special indicia, with the upper reels and the lower reels presented as mirror images of one another.

According to another aspect of the disclosure, a method for playing a game of chance includes displaying one of the upper reels, or lower reels on a graphical user interface. The method also includes causing the graphical user interface to spin the one of the upper or lower reels presented on the graphical user interface in response to a user engaging an input device, and randomly presenting a first randomized arrangement of indicia on the one of the upper or lower reels. The method also includes determining if a special occurrence has occurred based on the first randomized arrangement of the indicia. The method also includes displaying the other of the upper or lower reels on the graphical user interface in response to the determination of the special occurrence, wherein the upper and lower reels are presented as mirror images of one another.

According to another aspect of the disclosure, a system for playing a game of chance includes a graphical user interface separated into an upper reel segment and a lower reel segment by a horizontal line. The upper reel segment is configured to present a plurality of upper reels, and the lower reel segment is configured to present a plurality of lower reels. An input device is configured to permit a user to cause the graphical user interface to present spinning of one of the upper and lower reels, and to display a first randomized arrangement of indicia on the one of the upper and lower reels. The upper and lower reels are presented as mirror images of one another in response to a detection of a special indicia among the first randomized arrangement of indicia.

The presentation of the upper and lower reels as mirror images of one another provides a unique visual effect, leading to increased excitement to players of the game of chance. This aspect may be used in conjunction with a multiplier of potential prizes to further enhance the gaming experience.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1 is a perspective view of a gaming kiosk for a game of chance for presenting a graphical user interface, according to an aspect of the disclosure;

FIG. 2 is a front view of an embodiment of the graphical user interface of the game of chance and associated information, presenting initial gameplay in which only a lower set of reels is shown in on the graphical user interface;

FIG. 3 is a front view of an embodiment of the graphical user interface of the game of chance and associated information, presenting special gameplay in which both the lower and upper sets of reels are shown as mirror images of one another on the graphical user interface; and

FIG. 4 is a flow diagram of an embodiment of an embodiment of a method for playing the game of chance.

### DESCRIPTION OF THE ENABLING EMBODIMENT

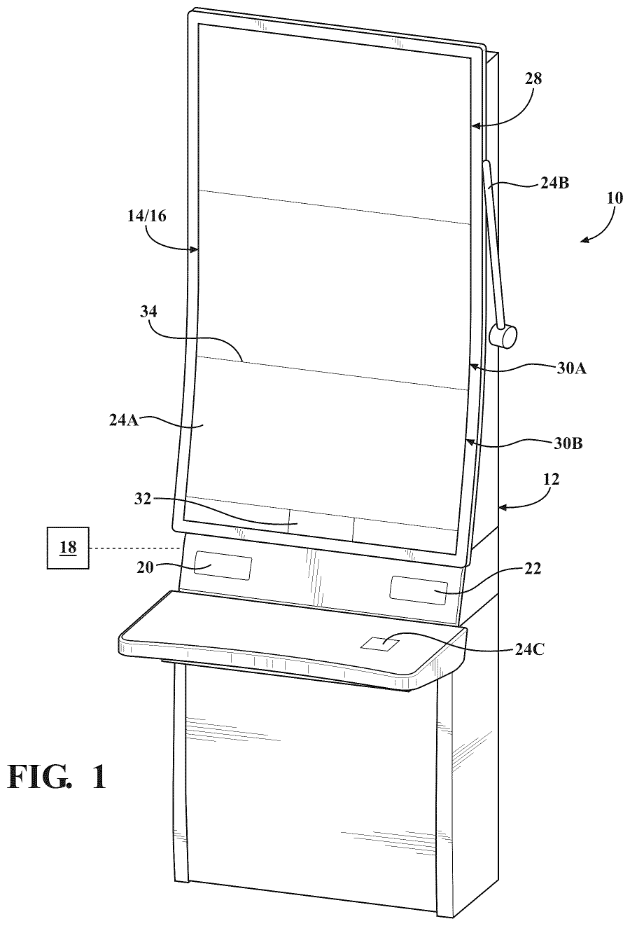

Referring to the figures, wherein like numerals indicate corresponding parts throughout the several views, embodiments of a system and method for playing a game of chance are provided. As shown in FIG. 1, the system 10 may include a kiosk 12 which includes a display device 14 which is configured to present a graphical user interface (GUI) 16. Other arrangements of display devices 14 may be used, such as a tablet, personal computer or smart phone. The subject game may be played in both casino or at home/mobile settings.

The system 10 also includes at least one processing device 18 (schematically shown), a currency transferring mechanism 20, 22 and at least one input device 24A, B, C. The display device 18, currency transferring mechanism 20, 22 and input device 24A, B, C are electrically connected to the processing device 18 for receiving and transmitting information therebetween. The term “processing device” as used herein encompasses various types of processors and associated components such as those found in personal computers, smart phones, tablets, etc. For example, the processing device 24 may include a processor and associated non-transitory computer-readable storage media storing computer-executable instructions that, when executed by the processor, instruct devices (such as the display device 14, currency transferring mechanism 20, 22 and input device 24A, B, C to perform actions). The processing device 18 may be connected to the internet and other electronic sources of information and databases for pulling information from various sources, for electronically managing the system and for linking multiple processing devices to one another.

According to the shown embodiment, the at least one input device 24 includes a touch screen 24A of the display device 14, a lever 24B and a button 24C. The input devices 24 are configured to allow a user to provide inputs associated with the game. Other types of input devices could be employed including but not limited to, a keyboard or a microphone for receiving voice commands.

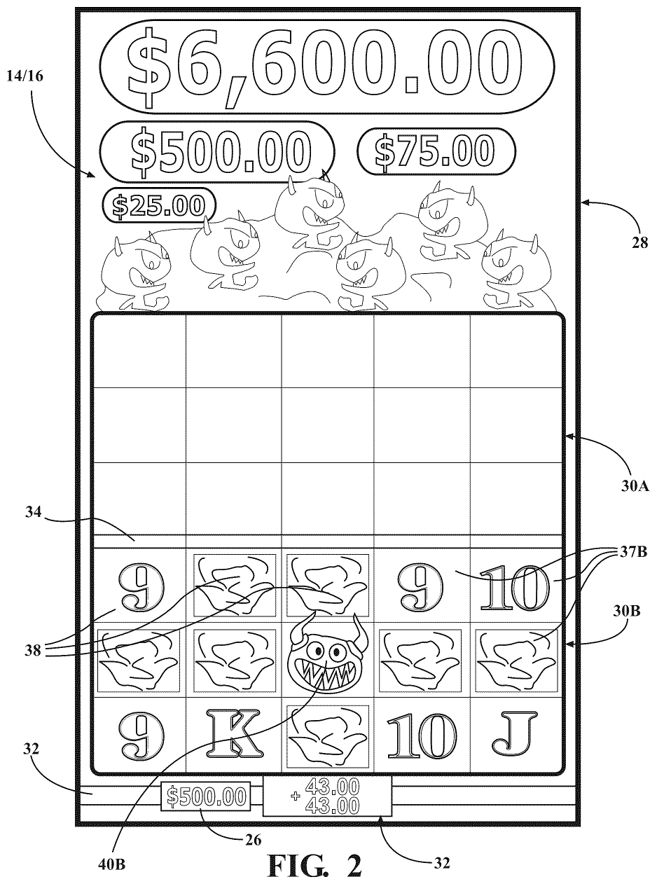

The currency transferring mechanism 20, 22 is electrically connected with the processing device 18 for transferring funds between a user account and an account associated with the game. As shown in FIG. 2, a balance 26 of a user's sub-account of the game account may be shown on the graphical user interface 16. The currency transferring mechanism 20, 22 may include a currency receiving mechanism 20 for receiving funds from the user, and a currency emitting mechanism 22 for transferring funds from the game account to the user. The currency transferring mechanism 20, 22 may be entirely electronic, thus allowing a user to electrically transfer funds from and to various user accounts such as personal bank accounts or credit cards via an internet connection. Alternatively, the currency transferring mechanism 20, 22 may include cash and/or ticket receiving and distributing mechanisms. According to such an embodiment, the user's cash constitutes their user account.

As shown, the GUI 16 includes an informational section 28 along a top of the GUI 16. The informational section 28 may display information including, but not limited to, a jackpot amount, minimum bet, a name of the game, and betting odds. A reel section 30A, 30B is positioned beneath the informational section 28. The reel section 30A, 30B is divided between an upper reel segment 30A and a lower reel segment 30B along a horizontal divider 34. The divider 34 may be a physical divider which separates the screen display 14 into two respective screens, or may be an electronically displayed divider which is part of a single screen. According to embodiments, the upper and lower reel segments 30A, 30B are the same size in the height and width directions, but may have other sizes and arrangements. A notification section 32 is positioned beneath the reel section 30A, 30B. The notification section 32 may display various types of information, including a prize amount, a balance, and wager information.

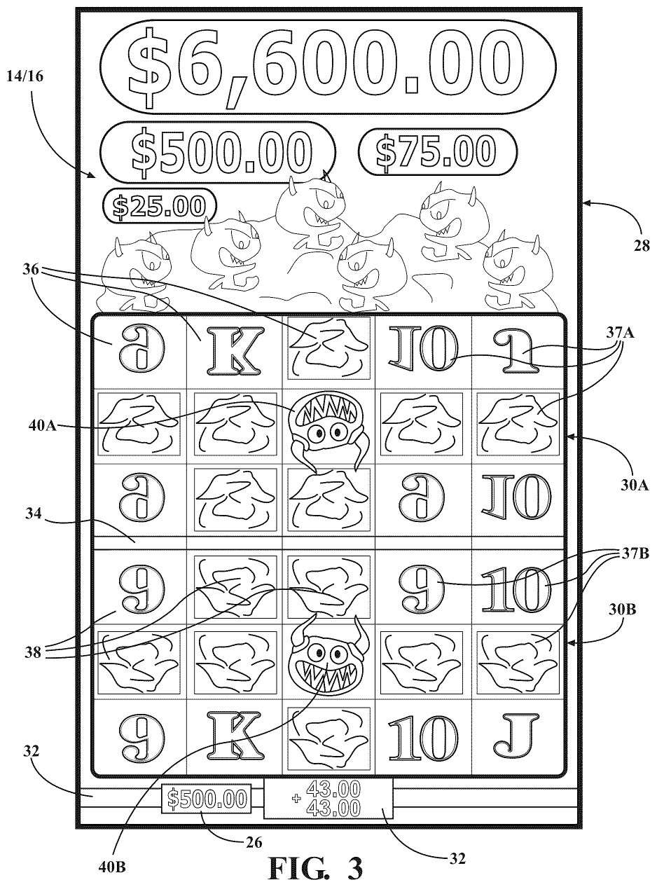

As best shown in FIG. 3, the upper reel section 30A is configured to display a plurality of upper reels 36, which together at any point display an arrangement of a predetermined number of upper indicia 37A. Likewise, the lower reel section 30B is configured to display a plurality of lower reels 38, which together at any point display an arrangement of a predetermined number of lower indicia 37B. During play, the upper and lower reels 36, 38 are configured to rotate upon engagement of the input device 24A, B, C by the player to present randomized arrangements of the upper and lower indicia 37A, 37B. In the shown embodiments, the upper and lower reels 36, 38 at any given time each display fifteen of the indicia 37A, 37B, positioned in three rows and five columns, but other numbers and arrangements of the indicia 37A, 37B could be used.

As will be discussed in further detail below and as shown in FIG. 2, during initial gameplay, only one of the upper and lower reel segments 30A, 30B is displayed, with the other segment 30A, 30B blank or displaying other content. According to the shown embodiment, only the lower reels 38 are shown during normal gameplay. The user then places a wager and activates the input device 24A, 24B, 24C, which causes the displayed reels 36, 38 of the upper or lower reel segment 30A, 30B to rotate and present a first randomized arrangement of the indicia 37A, 37B. At this time, the user may be paid out a first payout based on the wager and a first set of odds. Various styles of bonus games may be played at this time. The processing device 18 is configured to detect the presence of a special indicia 40A, 40B associated with the first random arrangement of indicia 37A, 37B.

If the special indicia 40A, 40B is detected, the missing one of the upper and lower reels 36, 38 is displayed as a mirror image of the initially presented one of the upper and lower reels 36, 38 and are configured to spin at the same time as one another in response to activation of the input device 24A, 24B, 24C. In other words, the symbols of the two segments 30A, 30B are inverted relative to one another. According to other embodiments, the upper and lower reels 36, 38 could be presented in other ways relative to one another, for example the lower reel 38 could be a 180 degree rotated image of the upper reel 36. According to embodiments, during this phase of the game in which both the upper and lower reels 36, 38 are presented as mirror images, the winnings of the game may be multiplied by a predetermined factor, like two. For example, the winnings may be based on a second set of odds that are twice that of the first set of odds associated with only one of the upper and lower reels 36, 38 being presented, to establish the two reel game as a bonus game with more favorable odds.

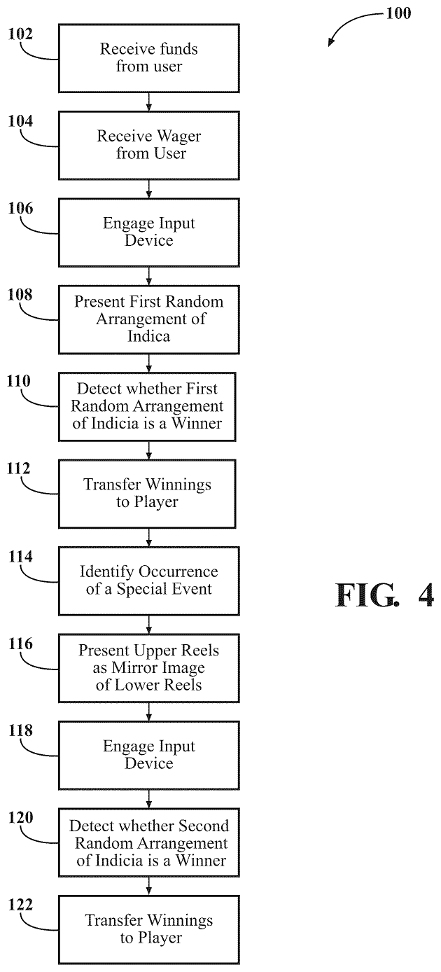

With reference to FIG. 4, a method 100 of playing a game of chance is provided. The method includes 102 receiving funds from the user with the currency transferring mechanism 20, 22. The method also includes 104 receiving a wager from the user. The wager may be made in accordance with conventional slot machine rules where the user is rewarded based on whether combinations of the symbols on one of the reels 36, 38 will be arranged in specific patterns after spinning. The wager information may correlate with a payout table and associated first sets of odds which pay different amounts based on different combinations of the indicia 37A, 37B. The user may also elect to wager on different numbers and arrangements of pay lines across the reels 36, 38, on which winning combinations may be established. For example, a user may wager on one or more pay lines that extend horizontally and/or diagonally across the reels 36, 38. After the wager is established, the method includes 106 the user engaging the input device 24A, B, C, and 108 spinning the presented one of the upper or lower reels 36, 38. According to the primary embodiment, the lower reels 38 are spun during normal gameplay, but according to other embodiments, the upper reels 36 could spin during normal gameplay. The method further includes 108 presenting a first random arrangement of the indicia 37A, 37B on the presented one of the upper or lower reels 36, 38. The method continues with 110 detecting whether the first random arrangement of the indicia 37A, 37B constitutes a winning spin based on the payout table and the first set of odds, and if so, 112 transferring funds to the player based on the established winnings with the currency transferring mechanism 20, 22.

The method further includes 114 identifying the occurrence of a special event. According to embodiments, 114 detecting the occurrence of the special event may include detecting a presence of special indicia 40A, 40B, such as a devil head 40, on the presented reel 36, 38. In response to the detection of the special event, the method continues with 116 presenting the other of the upper and lower reels 36, 38 which was not initially presented, with the upper and lower reels 36, 38 presented as mirror image of one another. According to embodiments, during this special event, prize winnings are multiplied, e.g., by a factor of two, based on the second set of odds. Furthermore, according to embodiments, other special games/multipliers which are available during normal play may be deactivated such that only rules associated with the special event are available. The method further includes 118 the user again engaging the input device 24A, B, C, and 108 spinning the both of the upper and lower reels 36, 38 and presenting a second random arrangement of the indicia 37A, 37B. The method continues with 120 detecting whether the second random arrangement of the indicia 37A, 37B constitutes a winning spin based on the second payout table and the second set of odds, and if so, 122 transferring funds to the player based on the established winnings with the currency transferring mechanism 20, 22. The special event may comprise a predetermined number of spins of the reels 36, 38 via the input device 24A, B, C, e.g., six spins, after which the game returns to normal play with only one of the reels 36, 38 presented.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in that particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or later, or intervening element or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to described various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in any embodiment, even if not specifically shown or described. The same may also be varied in many ways. Such variations are not to be regarded as a departure from the disclosure, and all such modifications are intended to be included within the scope of the disclosure.

What is claimed is:

1. A method for playing a game of chance, comprising:
providing a graphical user interface having an upper segment and a lower segment, with the upper segment positioned above the lower segment;
displaying one of a plurality of upper reels on the upper segment or a plurality of lower reels on the lower segment;
displaying the one of the upper reels or the lower reels spinning in response to activation of an input device by a user, and displaying a first randomized arrangement of indicia on the one of the upper or lower reels;
identifying a presence of a special indicia among the first randomized arrangement of indicia;
displaying the other of the upper reels on the upper segment or the lower reels on the lower segment in response to the identification of the special indicia, with the upper reels and the lower reels presented as mirror images of one another.

2. The method as set forth in claim 1, further including displaying the upper and lower reels spinning simultaneously in response to activation of the input device by the user after the upper and lower reels are presented as mirror images of one another, and displaying a second randomized arrangement of the indicia on the upper and lower reels.

3. The method as set forth in claim 1, further including receiving a wager from a player, and establishing whether the user is entitled to a first payout based on the first randomized arrangement of the indicia on the one of the upper or lower reels and based on a first set of odds.

4. The method as set forth in claim 3, further including establishing whether the user is entitled to a second payout based on a second randomized arrangement of the indicia on the upper and lower reels and based on a second set of odds being distinguishable from the first set of odds.

5. The method as set forth in claim 4, wherein the odds of the second set of odds are twice as large as the odds of the first set of odds.

6. The method as set forth in claim 1, wherein the upper reels are positioned above the lower reels and are mirror images of one another relative to a horizontal line extending horizontally across the graphical user interface.

7. The method as set forth in claim 6, wherein the upper and lower segments are the same size as one another.

8. A method for playing a game of chance, comprising:
displaying one of upper reels, or lower reels on a graphical user interface;
causing the graphical user interface to spin the one of the upper or lower reels presented on the graphical user interface in response to a user engaging an input device, and randomly presenting a first randomized arrangement of indicia on the one of the upper or lower reels presented on the graphical user interface;
determining if a special occurrence has occurred based on the first randomized arrangement of the indicia; and
displaying the other of the upper or lower reels on the graphical user interface in response to the determination of the special occurrence, wherein the upper and lower reels are presented as mirror images of one another.

9. The method as set forth in claim 8, further including causing the upper and lower reels to spin simultaneously in response to activation of the input device by the user after the upper and lower reels are presented as mirror images of one another, and presenting a second randomized arrangement of the indicia on the upper and lower reels.

10. The method as set forth in claim 9, further including receiving a wager from a player, and establishing whether the user is entitled to a first payout based on the first randomized arrangement of the indicia on the one of the upper or lower reels and based on a first set of odds.

11. The method as set forth in claim 10, further including establishing whether the user is entitled to a second payout based on the second randomized arrangement of the indicia on the upper and lower reels and based on a second set of odds being distinguishable from the first set of odds.

12. The method as set forth in claim 11, wherein the odds of the second set of odds are twice as large as the odds of the first set of odds.

13. The method as set forth in claim 8, wherein the upper reels are positioned above the lower reels and mirror images of one another relative to a horizontal line extending horizontally across the graphical user interface.

14. The method as set forth in claim 13, wherein the upper and lower segments are the same size as one another.

15. A system for playing a game of chance, comprising:
a graphical user interface separated into an upper reel segment and a lower reel segment by a horizontal line, wherein the upper reel segment is configured to present a plurality of upper reels, and the lower reel segment is configured to present a plurality of lower reels;
an input device configured to permit a user to cause the graphical user interface to present spinning of one of the upper and lower reels, and to display a first randomized arrangement of indicia on the one of the upper and lower reels; and
the upper and lower reels presented as mirror images of one another in response to a detection of a special indicia among the first randomized arrangement of indicia.

16. The system as set forth in claim 15, wherein the graphical user interface is configured to present the upper and lower reels spinning simultaneously in response to the detection of the special indicia and activation of the input device, and to present a second randomized arrangement of the indicia on the upper and the lower reels.

17. The system as set forth in claim 16, wherein the input device is further configured to receive a wager from the user, and wherein a controller is configured to establish whether the user is entitled to a first payout based on the first randomized arrangement of the indicia on the one of the upper or lower reels and based on a first set of odds.

18. The system as set forth in claim 17, wherein the controller is further configured to establish whether the user is entitled to a second payout based on the second randomized arrangement of the indicia on the upper and lower reels and based on a second set of odds being distinguishable from the first set of odds.

19. The system as set forth in claim 18, wherein the odds of the second set of odds are twice as large as the odds of the first set of odds.

20. The system as set forth in claim 15, wherein the upper reels are positioned above the lower reels and mirror images of one another relative to a horizontal line extending horizontally across the graphical user interface.
